(19) United States
(12) Patent Application Publication
(10) Pub. No.: US 2007/0278822 A1
(43) Pub. Date: Dec. 6, 2007

(54) Exterior Sliding Door for a Vehicle

(76) Inventor: Jens Mueller, Stuttgart (DE)

Correspondence Address: KENYON & KENYON LLP, ONE BROADWAY, NEW YORK, NY, 10004, US

(21) Appl. No.: 10/558,034

(22) PCT Filed: Apr. 24, 2004
(86) PCT No.: PCT/EP04/04364

§ 371 Date: Oct. 24, 2006

(30) Foreign Application Priority Data
May 20, 2003 (DE) 103 23 043.2

(51) Int. Cl. B60J 5/06; E05D 15/06

(52) U.S. Cl. 296/155; 49/209

(57) ABSTRACT

An exterior vehicle door is guided in a sliding manner in guide rails. At least one guide rail is provided which is mounted fixedly on the vehicle body and which includes a first section extending diagonally to the door plane and a second section extending approximately parallel to the door plane. A door guide rail is arranged on the vehicle door in the region of its lower edge. The body-mounted door rail is arranged in the region of an upper edge of the vehicle door.

### FIELD OF THE INVENTION

The present invention relates to a sliding exterior vehicle door.

### BACKGROUND INFORMATION

Small and medium-size transportation vehicles are provided at their side with a displaceable exterior vehicle door by which a loading space is conveniently accessible from the edge of a curb, for example. Relatively large passenger vehicles, often referred to as vans, are provided in some versions with such lateral exterior sliding doors, which allow easy access to the rear seats of the vehicle. The displaceable exterior doors are guided in guide rails, with one guide rail, which is mounted fixedly on the vehicle body, extending in the floor region of the vehicle. This guide rail includes a first section extending diagonally to the door plane and a second section extending approximately parallel to the door plane. In the closed state, the exterior vehicle door is arranged flush with the remainder of the body. Upon opening, the door is pushed diagonally outwardly at the start of the sliding operation by the diagonally extending first rail section, subsequent to which the door, guided in the second rail section, can slide along laterally outside of the remainder of the body. Further body-mounted guide rails are provided in the region of the upper edge of the door and also in the region of the center of the door, with all the guide rails together being intended to bring about tilt-free guidance.

Such guide rails take up a particularly large volume. In the region of the lower edge of the door opening they make it necessary, by virtue of their overall height, to have a comparatively high interior floor or a relatively high step.

For a relatively low floor, they protrude beyond the latter and constitute an obstacle when getting in and out or during loading and/or unloading. The bottom rail may be damaged as a result of being stood upon or coming into contact with bulky goods. The interior of the guide rail is exposed to considerable soiling via its open side, with cleaning being possible only with difficulty due to poor accessibility. A body-mounted guide rail at the level of the central door region includes a longitudinal slot for guiding through a runner, the longitudinal slot extending behind the closed sliding door through the exposed body surface. The visual appearance of the body surface is disrupted, with, in particular, the legibility of any applied lettering, logos, company advertising, etc. being impaired.

German Published Patent Application No. 43 14 115 describes a door guide rail which is integrated into a vehicle door and, given its central arrangement in the vehicle door, is intended at the same time to serve as protection against side impacts. The covering of a slot which extends on the inner side of the door and is intended for guiding through a runner bearing arrangement is covered by a peripheral band. The operation of covering the slot by the peripheral band is complicated. The inner door shell is interrupted in the region of the rail, thereby impairing both its load-bearing capacity and its visual appearance.

### SUMMARY

An example embodiment of the present invention may provide a sliding exterior vehicle door such that, in combination with little outlay on construction, easy accessibility to the vehicle interior may be made possible without impairing the body surface.

According to an example embodiment of the present invention, an exterior vehicle door is guided displaceably in guide rails, there being provided at least one guide rail which is mounted fixedly on the vehicle body and a further guide rail which is being designed as a door guide rail and arranged on the vehicle door. The guide rail mounted fixedly on the vehicle body includes a first section extending diagonally to the door plane and via which the door is lifted, upon opening, out of its position in which it is flush with the remainder of the body. In a second section extending approximately parallel to the door plane, the vehicle door may be slid along outside the body into its fully opened position. The body-mounted door rail is arranged in the region of an upper edge of the vehicle door and the door guide rail provided on the vehicle door is arranged in the region of its lower edge and, e g., integrated into this edge. This may ensure that the body-mounted door rail is arranged outside of the stepping and loading region and is not susceptible to damage and soiling.

The arrangement of the door guide rail in the region of the lower door edge results in the lower edge of the door opening being free of any guide rails. A step, and if appropriate the floor behind it too, may be lowered by about, e.g., 40 mm to 70 mm, thereby facilitating access and reducing loading on or damage to the opening frame in this region. The arrangement of the door-mounted door guide rail on the lower edge of the guide rail may not impair the structure of the door. An inner shell of the door may be constructed continuously in a cost-saving manner with high surface load-bearing capacity. The door rail is arranged outside an internal access region, thereby reducing the risk of damage. The visual appearance of the inner side of the door is not impaired, making it possible to dispense with complicated coverings, etc.

The vehicle door may have a 3-point bearing in which a respective door-mounted runner which forms a bearing point in each case is provided, with respect to an opening direction, in the region of a front upper corner and in the region of a rear upper corner of the vehicle door. Each of these runners extends in a respective body-mounted guide rail. Furthermore, there is arranged a third bearing point arranged in the region of a rear lower corner of the door opening. All the bearing points may be arranged such that access to the door opening is not impeded. The 3-point bearing may result in a spatially statically determined suspension of the door while avoiding canting effects. Dispensing with a statically overdetermined bearing means that the sliding door may remain smooth-running even if stress forces act on the vehicle body, for example, as a result of the vehicle being parked with only one wheel on the curb.

The above-described 3-point bearing may provide the possibility of dispensing with a guide rail at the central door level. The surface of the body is unimpaired in this region. Lettering, etc. may be applied in a clearly legible manner.

The vehicle door may be suspendably mounted in the body-mounted guide rail. Because the body-mounted guide rail is used to take up the weight of the vehicle door, the door-side door guide rail is loaded only in terms of small lateral forces. The guide rail itself and also the associated bearing point may accordingly be dimensioned to be lightweight.

At least one body-mounted guide rail may be arranged behind a lateral window pane, with the result that the guide rail is not arranged within the region of vision. A screen may be provided for the body-mounted guide rail. Not only may there be an improvement in the visual appearance but also an improvement in the aerodynamics together with a reduction in the susceptibility to soiling and damage.

A pivoting arm which is mounted fixedly on the body may be provided to form the third bearing point, the door guide rail extending substantially rectilinearly and guiding a runner on the pivoting arm. The pivoting arm allows an outward movement of the door out of the closed door plane. The door may subsequently be displaced parallel to the outer body surface in the rectilinearly extending door guide rail. The rectilinear profile of the door guide rail may demand only a small space requirement in the lateral direction, as a consequence of which the door may be designed to be comparatively narrow in the region of its lower edge. Pivoting arms of different lengths may provide that a door hereof may be applied even in vehicles having wheel housings or fenders of different lengths or widths, for example, in the case of dual-tire vehicles, thereby considerably simplifying the formation of variants.

The runner on the pivoting arm may have a running wheel having an axis of rotation arranged in the door plane and disposed perpendicularly to the opening direction. The running wheel thus predominantly takes up lateral forces. Small vertical forces at most may be introduced into the pivoting arm, as a consequence of which the pivoting arm is substantially free from bending forces. The pivoting arm and its fastening may be provided with correspondingly small dimensions and may be of simple design.

The door guide rail may have a downwardly open cross-section, the runner being mounted on the upper side of the pivoting arm and being introduced into the door guide rail from below. Spray particles, etc. may be unable to fall into the door guide rail. Condensation water, etc. may flow away readily.

The pivoting arm may be biased by a spring to pivot outwardly with respect to the door plane. Upon opening of the door, the latter is automatically moved outwardly in the lower region, with the correspondingly directed guidance being assisted by the diagonally extending section of the body-mounted guide rail and the manual force required for this purpose. The door may be opened comfortably and with little expenditure of force.

The pivoting arm may be latched in an outward position with respect to the door plane by a locking device. With the door half-opened or fully opened, the pivoting arm may not pivot inwardly unintentionally, avoiding a situation in which the door strikes the outer body surface. An unlocking device which acts on the locking device may be provided in the region of a rear end of the door guide rail with respect to the opening direction. Upon closing the door, it is only when the door is in the virtually closed state that the runner running in the door guide rail strikes this unlocking device, resulting in the locking device being released. Manual unlocking is not required, and unwanted, inadvertent unlocking with the door half-opened may be avoided.

To allow automatic opening or closing of the door, a drive which is arranged fixedly on the body, for example, an electric motor, may be provided which interacts with a transmission device arranged in the rail, such as a rack, and drives the door via the latter. It may thus be possible to dispense with electrical components in the sliding door, thereby making elaborate cable routing superfluous.

Example embodiments of the present invention are described in more detail below with reference to the appended Figures.

### BRIEF DESCRIPTION OF THE DRAWINGS

FIG. 1 is a perspective schematic view illustrating a closed sliding door.

FIG. 2 illustrates the arrangement illustrated in FIG. 1 with the door half-opened.

FIG. 3 is a schematic cross-sectional view of the sliding exterior vehicle door illustrated in FIGS. 1 and 2.

### DETAILED DESCRIPTION

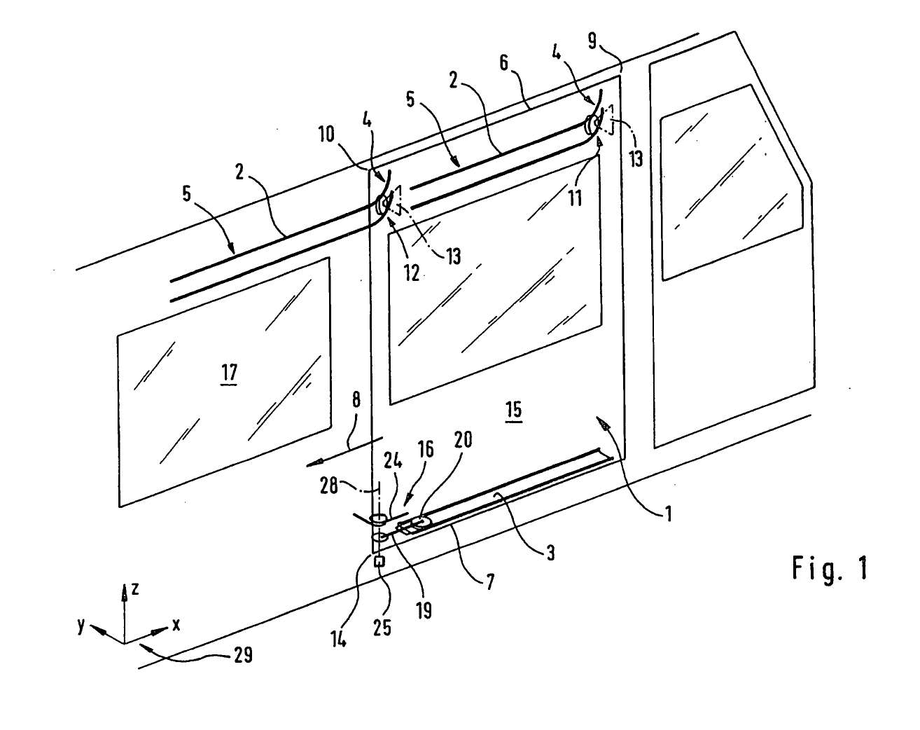

FIG. 1 is a perspective schematic view illustrating the outer side wall of a motor vehicle having a sliding exterior vehicle door 1. The vehicle door 1 is guided displaceably in guide rails 2, 3, with two body-mounted door rails 2 being arranged in the region of an upper edge 6 of the vehicle door 1. A door guide rail 3 integrated into the vehicle door 1 is arranged in the region of a lower edge 7 of the vehicle door 1. The two guide rails 2 mounted fixedly on the body each have a first section 4 extending diagonally to the door plane and, adjoining this first section, a second section 5 extending approximately parallel to the door plane.

The vehicle door 1 may be slid open from the closed position indicated in an opening direction indicated by an arrow 8. At the same time, a door opening 15 which may be closed by the vehicle door 1 is revealed. The vehicle door 1 has, with respect to the opening direction 8, a front upper corner 9 and a rear upper corner 10, whereas the door opening 15 has a rear lower corner 14. Provided in the three corners 9, 10, 14 is a respective bearing point 11, 12, 16 for the vehicle door 1, giving a 3-point bearing of the vehicle door 1 while dispensing with further bearing points.

The chosen designations “upper” and “lower” should be understood with reference to a vehicle coordinate system 29. The designation “rear” refers to the opening direction 8 which, in the exemplary embodiment illustrated, is directed counter to the positive X direction of the coordinate system 29. Configurations may also be provided in which the opening direction 8 is directed in the positive X direction of the coordinate system 29.

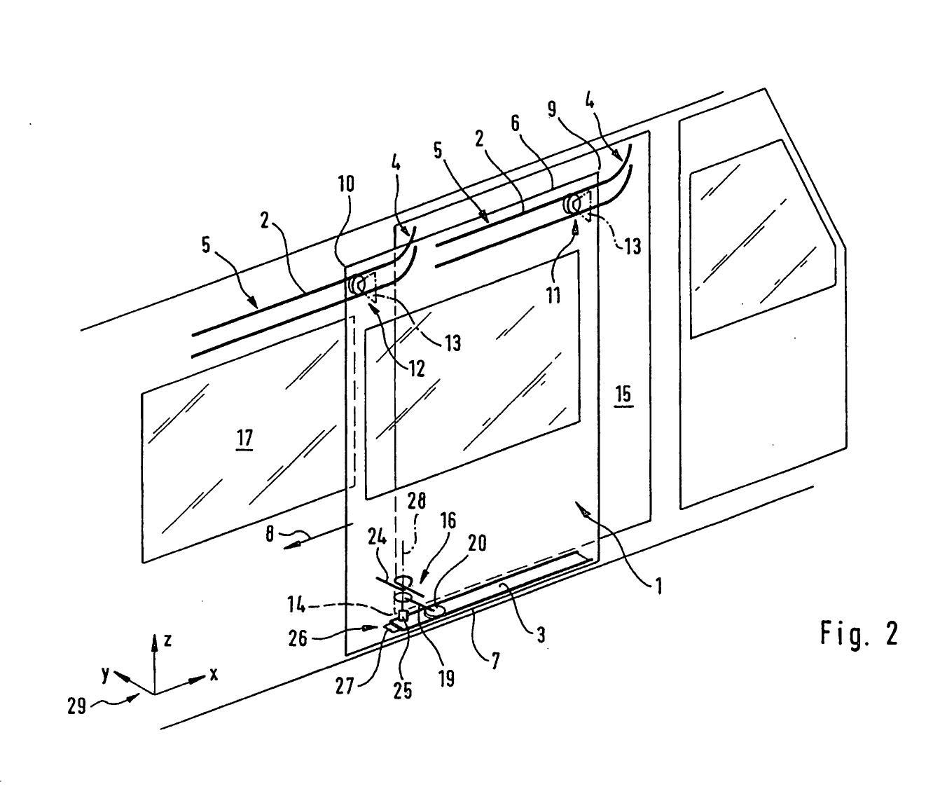

A runner 13, by which the vehicle door 1 runs in the body-mounted guide rails 2, is secured to the vehicle door 1 to form each of the upper bearing points 11, 12. A further runner 20 is held on a pivoting arm 19 mounted fixedly on the body and runs in the door guide rail 3 arranged in the vehicle door 1. The pivoting arm 19 may be pivoted outwardly out of the door plane about a vertical pivot axis 28 and biased by a spring 24 to pivot outwardly with respect to the door plane. A locking device 25 is provided by which the pivoting arm 19 may be latched in an outwardly pivoted position (FIG. 2) with respect to the door plane.

The rear body-mounted guide rail 2 extends above an indicated window pane 17 and is therefore covered by the body strip adjacent to the vehicle roof.

FIG. 2 illustrates the arrangement illustrated in FIG. 1 with the vehicle door 1 partly opened. The vehicle door 1 is initially guided out of the closed position illustrated in FIG. 1 along the first sections 4 of the guide rails 2 which project diagonally outwardly. The vehicle door 1 is lifted laterally out of a position in which it is flush with the remainder of the body and guided parallel to and on the outside of the body along the second sections 5 of the guide rails 2. Upon passage through the diagonally projecting first section 4, the pivoting arm 19 has pivoted outwardly from the position illustrated in FIG. 1 into the outer position illustrated in FIG. 2. The outwardly pivoting movement of the pivoting arm 19 is assisted by the biasing of the spring 24. When the pivoting arm 19 is in the pivoted position illustrated, the arm is latched by the locking device 25.

The runner 20 on the outer end of the pivoting arm 19 is guided in the door guide rail 3, the door guide rail 3 extending at least approximately rectilinearly.

An unlocking device 27 acting on the locking device 25 is provided in the region of a rear end 26 of the door guide rail 3 with respect to the opening direction 8. Upon closing the vehicle door 1 counter to the opening direction 8, the unlocking device 27 strikes the runner 20, thereby unlocking the locking device 25. The pivoting arm 19 is able to pivot inwardly, the vehicle door 1 being moved forwardly and inwardly by the pivoting arm 19 and the two diagonally projecting first sections 4 of the upper guide rails 2 into the closed position illustrated in FIG. 1.

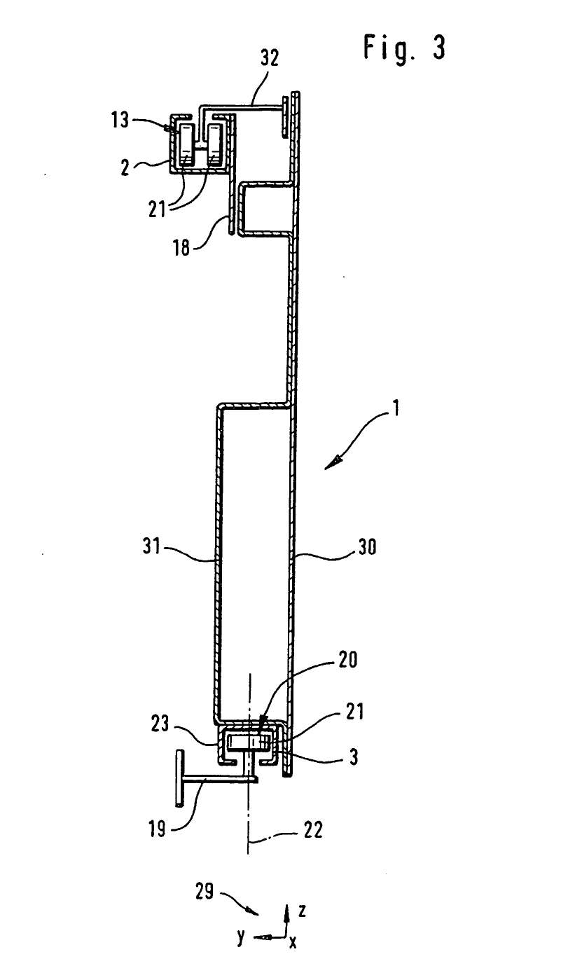

FIG. 3 is a schematic cross-sectional view illustrating the vehicle door 1 illustrated in FIGS. 1 and 2. The vehicle door 1 has an outer shell 30 and an inner shell 31. The door guide rail 3 is arranged below the inner shell 31 in that the rail has a downwardly open cross-section 23 with respect to the vehicle coordinate system 29. The runner 20 is mounted on the upper side of the pivoting arm 19 and is introduced into the door guide rail 3 from below. This runner 20 includes a running wheel 21 having an axis of rotation 22 arranged in the door plane and disposed perpendicularly to the opening direction 8 (FIGS. 1 and 2) or extending in the direction of the Z axis of the coordinate system 29.

The cross-sectional view illustrates the vehicle door 1 in the region of the front upper body-mounted guide rail 2 which, in the exemplary embodiment illustrated, is covered by a screen 18. The guide rail 2 is open at the top. It is also possible for the guide rail 2 to be arranged such that it is rotated through 900, with the result that it is open laterally toward the door. The upper runner 13 is secured to the vehicle door 1 by a cantilever arm 32. The cantilever arm 32 is bent off at an angle and engages into the guide rail 2 from above. In the exemplary embodiment illustrated, the runner 13 includes two running wheels 21 having a substantially horizontal axis of rotation, as a consequence of which the vehicle door 1 is suspendably mounted in the guide rail 2 to take up the weights occurring.

1-12. (canceled)

13. An exterior vehicle door, comprising:
a plurality of guide rails adapted to guide the door in a sliding manner, at least one body-mounted guide rail mounted fixedly on a vehicle body in a region of an upper edge of the door, the body-mounted guide rail including a first section extending diagonally to a door plane and a second section extending approximately parallel to the door plane, at least one door guide rail arranged in the door and arranged on a lower edge of the door; and
a three-point bearing, including door-mounted runners arranged as a bearing points running in the body mounted guide rail, a first door-mounted runner located in a region of a front upper corner of the door relative to a direction counter to an opening direction of the door, a second door-mounted runner located in a region of a rear upper corner of the door relative to the direction counter to the opening direction of the door, the three-point bearing including a third bearing point running in the door guide rail, arranged in a region of a real lower corner of a door opening and arranged fixedly on the vehicle body.

14. The exterior vehicle door according to claim 13, wherein the door guide rail is integrated into the door.

15. The exterior vehicle door according to claim 13, wherein the vehicle door is suspendedly mounted in the at least one body-mounted guide rail.

16. The exterior vehicle door according to claim 13, wherein one of the body-mounted guide rails is located behind a lateral window pane of the vehicle.

17. The exterior vehicle door according to claim 13, further comprising a screen covering the body-mounted guide rail.

18. The exterior vehicle door according to claim 13, wherein the door guide rail is substantially rectilinear and the third bearing point includes a pivot arm mounted fixedly on the vehicle body and a runner guided in the door guide rail.

19. The exterior vehicle door according to claim 18, wherein the runner includes a runner wheel having an axis of rotation arranged in the door plane and arranged perpendicularly to the opening direction.

20. The exterior vehicle door according to claim 18, wherein the door guide rail includes a downwardly open cross-section, the runner mounted on an upper side of the pivot arm and introduced into the door guide rail from below.

21. The exterior vehicle door according to claim 18, wherein the three-point bearing includes a spring, the pivot arm biased by the spring to pivot outwardly with respect to the door plane.

22. The exterior vehicle door according to claim 18, wherein the three-point bearing includes a lock device, the pivot arm latchable in an outwardly pivoted position with respect to the door plane by the lock device.

23. The exterior vehicle door according to claim 22, wherein the three-point bearing includes an unlock device arranged in a region of a rear end of the door guide rail with respect to the opening direction, the unlock device arranged to act on the lock device.

24. A motor vehicle, comprising:
an exterior vehicle door, including:
a plurality of guide rails adapted to guide the door in a sliding manner, at least one body-mounted guide rail mounted fixedly on a vehicle body in a region of an upper edge of the door, the body-mounted guide rail including a first section extending diagonally to a door plane and a second section extending approximately parallel to the door plane, at least one door guide rail arranged in the door and arranged on a lower edge of the door; and
a three-point bearing, including door-mounted runners arranged as a bearing points running in the body mounted guide rail, a first door-mounted runner located in a region of a front upper corner of the door relative to a direction counter to an opening direction of the door, a second door-mounted runner located in a region of a rear upper corner of the door relative to the direction counter to the opening direction of the door, the three-point bearing including a third bearing point running in the door guide rail, arranged in a region of a real lower corner of a door opening and arranged fixedly on the vehicle body.
